(19) United States
(12) Patent Application Publication
(10) Pub. No.: US 2013/0310428 A1
(43) Pub. Date: Nov. 21, 2013

(54) THERMO-STABLE, ARSENIC-FREE SYNERGISTIC BIOCIDE CONCENTRATE COMPOSITION FOR POLYMER MATRICES AND PROCESS FOR PREPARING SAME

(71) Applicants: Bartko Joseph, Nazareth, PA (US); Karen Winkowski, Springfield, NJ (US)

(72) Inventors: Bartko Joseph, Nazareth, PA (US); Karen Winkowski, Springfield, NJ (US)

(73) Assignee: ISP INVESTMENTS INC., Wilmington, DE (US)

(21) Appl. No.: 13/817,294

(22) PCT Filed: Aug. 5, 2011
(86) PCT No.: PCT/US11/46688

§ 371 Date: Apr. 12, 2013

Related U.S. Application Data
(60) Provisional application No. 61/374,433, filed on Aug. 17, 2010.

(51) Int. Cl. A01N 43/38; A01N 43/78; A01N 43/80; A01N 47/12

(52) U.S. Cl. CPC A01N 43/38; A01N 47/12; A01N 43/78; A01N 43/80
USPC 514/365; 514/417; 514/372

(57) ABSTRACT

A thermo-stable, arsenic-free synergistic biocide concentrate composition to afford enhanced antimicrobial properties to a polymer matrix comprising (i) a mixture of trihalomethyl-thio-phthalimide analogue and a second biocide; (ii) an antioxidant; (iii) a carrier; and (iv) optionally, one or more additives. The composition is capable of withstanding high processing temperatures up to about 250° C., substantially without thermal degradation of biocides and discoloration of the polymer matrix employed.

### FIELD OF THE INVENTION

The present application relates to biocide concentrate compositions, and more particularly, to a thermo-stable, arsenic-free biocide concentrate composition comprising at least one biocide selected from trihalomethyl-thio-phthalimide and a second biocide.

### BACKGROUND OF THE INVENTION

Plastics or polymers have become well recognized materials for manufacturing various types of articles in the fields of floral, medical, industrial and the like. These plastics are typically made of polymers and additives. Typical polymers include, without limitation vinyls, acrylics, styrenes, polyolefins, polyurethanes, polycarbonates, polyamides, imides, etc. In the manufacture of plastics, plasticizers such as phthalates, adipates, esters, etc. typically are added as one of the additives to improve the physical characteristics of the resulting polymers and these plasticizers may be susceptible to microbial attack. Also, there are other nutrient bearing ingredients such as wood, cellulosics, rice-hull, etc. that may be added to produce the plastic formulations which can make them susceptible to microbial attack.

As a result, in many applications, the polymeric or plastic materials, or an item contained in a polymeric or plastic article made therefrom may be prone to attack and contamination by microorganisms such as bacteria and/or fungi due to the susceptibility of plasticizers to microorganisms. This microbial attack not only affects the aesthetic of the product, but may also result in unpleasant odors, staining, embrittlement of the plastics and can eventually lead to an failure product. Particularly, actinomycetes can grow on the surfaces of polymeric materials and can produce dyes as a byproduct which is soluble in plasticizers employed in the manufacture of polymeric materials. Further, actinomycetes can migrate through the substance via the plasticizer, resulting in the phenomenon known as “pink staining.” Additionally, the surface growth of microorganisms on polymeric materials may hinder functional performance, for instance when used as lubricating surfaces. So, a polymeric or plastic material capable of destroying or inhibiting foreign microorganisms would be desirable. Hence, the integration of a biocidal active ingredient into these type of polymeric materials is widely explored and these biocide integrated polymeric materials are used in various types of end-use applications to offer advantageous results with regard to growth of bacteria or fungi.

Many of the industrial biocides currently used in connection with plastics, polymers and cellulosic fibers are organometallics. One of the most commercially used biocides is 10,10-oxybisphenoxarsine (OPBA), which is very effective in preventing microbial attack on such materials and cost effective. Because of its highly leachable property, it offers an effective zone of inhibition in accelerated microbial testing and it also has the ability to withstand high processing temperature ranges in the manufacture of plastics or polymeric materials. However, such compounds may not be suitable for many industrial applications. Thus, there is a need for alternative heavy metal-free biocide products that would offer similar or better protection than OPBA.

PCT Publication No. WO2008047097 assigned to Syngenta Participations AG discloses an antifungal coating composition, in particular paint, capable of controlling fungi on an industrial material. The publication describes compositions comprising: (A) an isothiazolone; (B) thiabendazole and (C) propiconazole and wherein a particular embodiment reveals that (A), (B) and (C) are present in amounts which produce a synergistic fungicidal effect.

PCT Publication No. WO2007031198 assigned to Lanxess Deutschland GMBH discloses synergistic mixtures based on the active substance triclosan which are particularly suitable for protecting technical materials against attacks, damage, and/or destruction by micro-organisms, in particular, for protecting wood and wood materials against attacks and/or destruction by lignivorous fungi.

U.S. Patent Publication No. 20060013833 assigned to ISP Investments Inc. discloses a composition which includes (a) a matrix, (b) a biocide, and (c) an antioxidant, in which said biocide exhibits thermal stability at matrix processing temperatures of up to 250° C.

U.S. Pat. No. 5,023,281 assigned to Morton International, Inc. describes microbiocidal solutions comprising an aryl alkanol solvent and a microbiocidal compound dissolved therein. The solutions may be used to impart microbiocidal properties to polymer compositions. The selected microbicidal compounds are N-(2-methylnaphthyl)maleimide, bis-N-[1,1,2,2-tetrachloroethy)thio]-4-cyclohexene-1,2-dicarboximide, N-trichloromethylthio-4-cyclohexene-1,2-dicarboximide, N-trichloromethylthio phthalimide (Folpet) and 2-(n-octyl-4-isothiazolin-3-one) (BIT).

U.S. Pat. No. 5,319,000 assigned to Olin Corporation discloses storage-stable dispersions of solid biocides in plastisols which are provided by causing carrier absorption into the polymer to occur under elevated temperature conditions. The resulting dispersions are storage-stable against settling and against “setting-up” that would otherwise tend to occur during warehousing of the dispersions prior to use. The disclosed biocides are selected from the group consisting of sodium pyrithione, zinc pyrithione, chitosan pyrithione, and combinations thereof.

U.S. Pat. No. 6,399,560 assigned to Novapharm Research (Australia) Pty Ltd discloses a biocidal concentrate including zinc pyridinethione; and a second biocide selected to be biocidally effective in a pH range complementary to zinc pyridinethione. The second biocide may be an aromatic halogenated phenol such as triclosan, dichlorophen and trichlorcarban. The invention also provides biocidal cleaning devices and plastic materials and methods of manufacture thereof.

U.S. Pat. No. 6,846,777 assigned to Thor GmbH discloses a biocide composition as an additive to materials capable of being attacked by harmful microorganisms, comprising as biocidal active ingredients zinc pyrithione and 3-iodo-2-propinyl-N-butylacarbamate as well as 2-n-octylisothiazolin-3-one or 4,5-dichloro-2-n-octylisothiazolin-3-one or a mixture of both.

PCT Publication No. WO2008132060 discloses the use of a biocidal mixture containing IPBC and TBZ for the protection of wood-plastic composites (WPC) containing a thermoplastic polymer and wood particles from infestation and/or destruction by microorganisms; PCT Publication No. WO2010015552 describes stable antifungal liquid formulations for protecting material, containing 3-iodopropynyl butyl carbamate (IPBC), n-octylisothiazolinone (n-OIT), and a solvent that has a minimum boiling point of 250° C. at the standard pressure and contains at least two functional groups selected from among ether groups, ester groups, amide groups, or alcohol groups; and U.S. Pat. No. 5464622 discloses a synergistic antimicrobial composition comprising 2-mercaptopyridine N-oxide, and salts thereof, and iodopropargyl butylcarbamate (IPBC) in a ratio to each other which exhibits synergism.

Accordingly, the present application describes a thermo-stable, arsenic-free and synergistic biocide concentrate composition having equal or better efficacy than widely utilized OPBA.

### SUMMARY OF THE INVENTION

The present application relates to a thermo-stable, arsenic-free synergistic biocide concentrate composition to impart enhanced microbicidal properties to a polymer matrix comprising (i) (a) about 2.5 to about 50.0 wt % of trihalomethyl-thio-phthalimide and (b) about 0.5 to about 25.0 wt % of a second biocide; (ii) about 0.5 to 20 wt % of an antioxidant; (iii) a carrier; and (iv) optionally, one or more additives.

In accordance with certain aspects, a biocide concentrate composition is provided which is capable of withstanding high processing temperatures up to about 250° C., substantially without thermal degradation of the biocide or discoloration of the polymer matrix present in the end use applications.

In a preferred aspect, N-[(trichloromethyl)-thio]-phthalimide is engaged as a biocide of the present concentrate composition.

Another aspect of the present application is to employ a second biocide along with N-[(trichloromethyl)-thio]-phthalimide preferably selected from the group consisting of N-butyl-1,2-benzisothiazolin-3-one (BBIT), 4,5-dichloro-n-octyl-4-isothiazolin-3-one (DCOIT), triclosan, 2-methyl-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (OIT), 3-iodo-2-propynylbutyl-carbamate (IPBC), oxyfluorfen, 3-iodopropynyl carbamate (IPC), 3-iodopropynyl-N-phenyl carbamate (IPPC), thiabendazole, terbutryn, zinc pyrithione (ZnPy), bronopol, diuron, dehydroacetic acid (DHA), dazomet and/or carbendazim.

In accordance with another aspect of the present application a synergistic biocide concentrate composition which is capable of exhibiting enhanced microbicidal activity with very lesser quantities of mixture of trihalomethyl-thio-phthalimide and a second biocide is provided.

Another aspect of the present application is to employ an antioxidant selected from the group consisting of hindered phenols, amines, aryl phosphates, and/or azoles.

In accordance with another aspect of the present application, the biocide concentrate composition is capable of inhibiting or killing Staphylococcus aureus, Klebsiella pneumonia, Pseudomonas areuginosa, Bacillus subtilus, Aspergillus niger, Aspergillus flavus, Oscillatoria tennis, Penicillin funiculosum, Chaetomium globosum, Aureobasidium pullulans, Trichoderma altlernaria alternata, Curvularia sp., Fusarium sp., Nigrospora sp., Helminthosporium Cladosporium sp., Gliocladium and/or. Streptoverticillium reticulum.

In yet another aspect, the additives for preparing the desired biocide concentrate composition may be selected from the group consisting of colorants, pigments, thermal stabilizers, ultraviolet stabilizers, radiation stabilizers, mold release additives, ignition resistant additives, fillers, reinforcing aids, blowing agents, plasticizers, flow enhancers, lubricants, anti-fogging agents, anti-static compositions, anti-blocking compounds, lubricants, heat stabilizers, coupling agents, extenders, impact modifiers, glass fibers flame retardants wood, wood flour and/or slip agents.

### DETAILED DESCRIPTION OF THE INVENTION

While this specification concludes with claims particularly pointing out and distinctly claiming that which is regarded as the invention, it is anticipated that the invention can be more readily understood through reading the following detailed description of the invention and study of the included examples.

By the term “comprising” herein is mean that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients such as biocide, antioxidant and additives if any of the biocide concentrate composition.

All percentages, parts, proportions and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present application shall include the corresponding plural characteristic or limitation, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

All publications, articles, papers, patents, patent publications, and other references cited herein are hereby incorporated herein in their entireties for all purposes to the extent consistent with the disclosure herein.

The term “arsenic-free” means that the biocide concentrate composition is free from arsenic in any form, particularly the salts of arsenic such as organic bound arsenic or inorganic bound arsenic.

The term “thermo-stable” means that the biocides present in the concentrate composition is stable at its elevated processing temperature of about 250° C.

The term “folpet analogues” and “trihalogenomethylthio phthalimide analogues” are synonymously used throughout this application.

The term “hindered phenolic antioxidant” as used herein refers to a compound having at least one phenolic substituent, in which the two positions ortho to the phenolic hydroxyl group are substituted, preferably with a tertiary alkyl group. The para position is preferably substituted with an alkyl group containing at least two hydrogens at the alpha positions to the para substituted alkyl group.

The term “biocide” or “antimicrobial” as used herein is to be understood to refer to agents such as germicides, bactericides, fungicides, algicides, aquaticides, herbicide, insecticide, larvicide, pesticide, rodenticide, taeniacide, plant growth regulators and the like, which are used for their ability to inhibit growth of and/or destroy biological and/or microbiological species such as bacteria, fungi, algae, caterpillar, insects, larvae, mildew, rodents, spider, worm and the like.

As used herein, the term “synergistic” refers to cases where the efficacy of a biocide concentrate composition comprising two different biocidal agents exceeds the sum of the antimicrobial efficacies of the individual antimicrobial agents employed alone. Therefore, using a synergistic antimicrobial composition can allow for the use of a lower overall concentration of antimicrobial agent to provide for enhanced antimicrobial efficacy at comparable antimicrobial concentrations.

In a particular embodiment of the present application, at least one biocide is selected from trihalomethyl-thio-phthalimide analogues to prepare the biocide concentrate composition. The preferred trihalomethyl-thio-phthalimide analogues would include but are not limited to captan, captafol, dichlofluanid, tolyfluanid, folpet and/or fluorfolpet. The most preferred trihalomethyl-thio-phthalimide analogue is trichloromethyl-thio-phthalimide (Folpet). The levels of trihalomethyl-thio-phthalimide analogues employed in the present application may be from about 2.5 to about 50.0 wt % of the total wt % of the composition.

The suitable second biocide employed to prepare the biocide concentrate composition may be selected from, but is not limited to, germicides, bactericides, fungicides, algicides, aquaticides, herbicides, insecticides, larvicides, pesticides, rodenticides, molluscicides and/or taeniacides. Further, the levels of second biocide employed in the present application may be from about 0.5 to about 25.0 wt % of the total wt % of the composition.

According to particular embodiment of the present application, the second biocide employed to prepare the biocide concentrate composition is selected from following non-limiting group of biocidal compounds: Triazoles: Azaconazole, bromuconazole, cyproconazole, dichlobutrazol, diniconazole, hexconazole, metconazole, penconazole, propiconazole, tebuconazole, amitrole, azocyclotin, epoxyconazole, bitertanol, difenoconazole, fenbuconazole, fenchlorazole, fenethanil, fluquinconazole, flusilazole, flutriafol, imibenconazole, isozofos, myclobutanil, paclobutrazol, (+)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles: Imazalil, pefurazoatc, prochloraz, trifiumizole. hiazolecarboxanilides, 2′,6′-dibromo-2-methyl-4-tri fluoromethoxy-4′-trifluoromethyl-1,3-thiazole-5-carboxanilide and their metal salts and acid adducts. Succinate dehydrogenase inhibitors: Fenfuram, furcarbanil, cyclafluramid, furmecyclox, seedvax, metsulfovax, pyrocarbolid, oxycarboxin, Shirlan, mebenil (mepronil), benodanil, flutolanil (Moncut); Naphthalene derivatives: Terbinafine, naftifine, butenafine; 10,10′ oxybisphenoxarsine; Benzimidazoles: carbendazim, benomyl, furathiocarb, fuberidazole, thiophonatmethyl, thiabendazole or salts thereof; Morpholine derivatives: tridemorph, fenpropimorph, falimorph, dimethomorph, dodemorph; aldimorph, fenpropidin and their salts with arylsulphonic acids, such as p-toluenesulphonic acid and p-dodecylphenyl-sulphonic acid; Dithiocarbamates: cufraneb, ferbam, mancopper, mancozeb, maneb, metam, metiram, thiram zeneb, ziram; Benzothiazoles: 2-mercaptobenzothiazole; Benzamides: 2,6-dichloro-N-(4-trifluoromethylbenzyl)-benzamide; Boron compounds: boric acid, boric esters, borax; Formaldehyde donors: benzyl alcohol mono-(poly)-hemiformal, oxazolidines, hexa-hydro-5-triazines, N-methylolchloracetamide, paraformadehyde, nitropyrine, oxolic acid, tecloftalam; Tris-N-(cyclohexyldiazeniumdioxy)-aluminium, N-(cyclo-hexyldiazeniumdioxy)-tributyl, K salts; Isothiazolones: N-Methylisothiazolin-3-one (MIT), 5-Chloro-2-methyl-4-isothiazolin-3-one (CMIT), 4,5-dichloro-N-octylisothiazolin-3-one (DCOIT), 2-Octyl-4-isothiazolin-3-one (OIT), 4,5-trimethylene-isothiazolinone, 1,2-Benzisothiazolin-3-one (BIT), N-butyl-1,2-benzisothiazolin-3-one (BBIT),; Aldehydes, such as cinnamaldehyde, formaldehyde, glutardialdehyde, β-Br-cinnamaldehyde; Thiocyanates: thiocyanatomethylthiobenzothiazole, methylenebisthiocyanate, and the like; Quaternary ammonium compounds: benzyldimethyltetradecylammonium chloride, benzyldimethyldodecylammonium chloride, didecyldimethylammonium chloride; Iodine derivatives: diiodomethyl p-tolyl sulphone, 3-iodo-2-propinyl alcohol, 4-chlorophenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propynyl-n-butylcarbamate (IPBC), 3-iodo-2-propinyl-n-butylurea, 3-iodo-2-propinyl-n-hexylcarbamate, 3-iodo -2-propinyl-cyclohexylcarbamate, 3-iodo -2-propinyl-N-phenylcarbamate (IPPC); Phenol derivatives: tribromophenol, tetrachlorophenol, 3-methyl-4-chlorophenol, 3,5-dimethyl-4-chlorophenol, phenoxyethanol, dichlorophen, o-phenylphenol, m-phenylphenol, p-phenylphenol, 2-benzyl-4-chlorophenol and their alkali metal salts and alkaline earth metal salts; Microbicides: chloroacetamide, N-methylolchloroacetamide, bronopol, bronidox, tectamer including 2-bromo-2-nitro-1,3-propanediol, 2-bromo-4′-hydroxy-acetophenone, 2,2-dibromo-3-nitrilo-propionamide, 1,2-dibromo-2,4-dicyanobutane, β-β-β-nitrostyrene; Pyridines: 1-hydroxy-2-pyridinethione and/or their Na, Fe, Cu, Mn, Zn salts thereof, Zinc pyrithione (ZnPy) tetrachloro-4-methylsulphonylpyridine, pyrimethanol, mepanipyrim, dipyrithione; Dialkyldithiocarbamates: sodium salts of dialkyldithiocarbamates, tetramethylthiuram disulphide, potassium N-methyl-dithiocarbamate; Nitriles: 2,4,5,6-tetrachloroisophthalonitrile, disodium cyano-dithioimidocarbamate; Quinolines: 8-hydroxyquinoline and their inorganic salts thereof, particularly, Cu salt; Other Biocides: Mucochlorie acid, 5-hydroxy-2(5H)-furanone, 4,5-Dichlorodithiazolinone, 4,5-benzodithiazolinone, 4,5-trimethylenedithiazolinone, 4,5-dichloro-(3H)-1,2-dithiol-3-one, 3,5-dimethyl-tetrahydro-1,3,5-thiadiazine-2-thione, N-(2-p-Chlorobenzoylethyl)-hexaminium chloride, potassium N-hydroxymethyl-N′-methyl-dithiocarbamate, 2-Oxo-2-(4-hydroxy-phenyl)acethydroximic acid chloride, Phenyl 2-chloro-cyano-vinyl sulphone, Phenyl 1,2-dichloro-2-cyano-vinyl sulphone, triclosan, dehydroacetic acid (DHA).

Fungicides: Methyl(E)-methoximino[α-(o-tolyloxy)-o-tolyl]acetate, methyl(E)-2-{2-[6-(2-cyanophenoxy)-pyrimidin-4-yl-oxy]phenyl}-3-methoxyaerylate, Acypetacs, 2-aminobutane, ampropylfos, anilazine, benalaxyl, bupirimate, chinomethionat, chloroneb, chlozolinate, cymoxanil, dazomet, diclomezinc, dichloram, diethofencarb, dimethirimol, diocab, dithianon, dodine, drazoxolon, edifenphos, ethirimol, etridiazole, fenarimol, fenitropan, fentin acetate, fentin hydroxide, ferimzone, fluazinam, fluorormide, flusulfamide, flutriafol, fosetyl, fthalide, furalaxyl, guazatine, hymexazol, iprobenfos, iprodione, isoprothiolane, metalaxyl, methasulfocarb, nitrothal-isopropyl, nuarimol, ofurace, oxadiyl, perflurazoate, pencycuron, phosdiphen, pimaricin, piperalin, procymidone, propamocarb, propineb, pyrazophos, pyrifenox, pyroquilon, quintozene, tar oils, tecnazene, thicyofen, thiophanate-methyl, tolclofos-methyl, triazoxide, trichlamide, tricyclazole, triforine, vinclozolin.

Insecticides: (i) Phosphates: azinphos-ethyl, azinphos-methyl, α-1(4-chlorophenyl)-4-(O-ethyl, S-propyl)phosphoryloxy-pyrazole, chlorpyrifos, coumaphos, demeton, demeton-S-methyl, diazinon, dichlorvos, dimethoate, ethoate, ethoprophos, etrimfos, fenitrothion, fenthion, heptenophas, parathion, parathion-methyl, phosalone, phoxim, pirimiphos-ethyl, pirimiphos-methyl, profenofos, prothiofos, sulfprofos, triazophos and trichlorphon; (ii) Carbamates: aldicarb, bendiocarb, α-2-(1-methylpropyl)-phenyl methylcarbamate, butocarboxim, butoxycarboxim, carbaryl, carbofuran, carbosulfan, cloethocarb, isoprocarb, methomyl, oxamyl, pirimicarb, promecarb, propoxur and thiodicarb; (iii) Organosilicon compounds: preferably dimethyl(phenyl)silyl-methyl 3-phenoxybenzyl ethers such as dimethyl-(4ethoxyphenyl)-silyl-methyl 3-phenoxybenzyl ether, or (dimethylphenyl)-silyl-methyl 2-phenoxy-6-pyridylmethyl ethers, such as e.g. dimethyl-(9-ethoxy-phenyl)-silylmethyl 2-phenoxy-6-pyridylmethyl ether or [(phenyl)-3-(3-phenoxyphenyl)-propyl](dimethyl)-silanes, such as e.g. (4-ethoxyphenyl)-[3-(4-fluoro-3-phenoxyphenyl-propyl]dimethyl-silane, silafluofen; (iv) Pyrethroids: allethin, alphamethrin, bioresmethrin, byfenthrin, cycloprothrin, cyfluthrin, decamethrin, cyhalothrin, cypermethrin, deltamethrin, α-cyano-3-propancarboxylate, fenpropathrin, fenfluthrin, fenvalerate, flucythrinate, flumethrin, fluvalinate, permethrin, resmethrin and tralomethrin; (v) Nitroimines and nitromethylenes: 1-[(6-chloro-3-pyridinyl)-methyl]-4,5-dihydro-N-nitro-1H-imidazole-2-amine(imidacloprid), N-[(6-chloro-3-pyridyl)methyl-]N²-cyano-N¹-methylacetamide; (vi) Others: Abamectin, acephate, acrinathrin, alanycarb, aldoxycarb, aldrin, amitraz, azamethiphos, bacillus thuringiensis, phosmet, phosphamidon, phosphine, prallethrin, propaphos, propetamphos, prothoate, pyraclofos, pyrethrins, pyridaben, pyridafenthion, pyriproxyfen, quinalphos, RH-7988, rotenone, sodium fluoride, sodium hexafluorosilicate, sulfotep, sulphuryl fluoride, tar oils, teflubenzuron, tefluthrin, temephos, terbufos, tetrachlorvinphos, tetramethrin, O-2-tert-butyl-pyrimidin-5-yl-o-isopropyl-phosphorothiate, thiocyclam, thiofanox, thiometon, tralomethrin, triflumuron, trimethacarb, vamidothion, verticillium lacanii, XMC, xylylcarb, benfuracarb, bensultap, bifenthrin, bioallethrin, MERbioallethrin (S)-cyclopentenyl isomer, bromophos, bromophos-ethyl, buprofezin, cadusafos, calcium polysulphide, carbophenothion, cartap, chinomethionat, chlordane, chlorfenvinphos, chlorfluazuron, chlormephos, chloropicrin, chlorpyrifos, cyanophos, beta-cyfluthrin, α-cypermethrin, cyophenothrin, cyromazine, dazomet, DDT, demeton-5-methylsulphon, diafenthiuron, dialifos, dicrotophos, diflubenzuron, dinoseb, deoxabenzofos, diaxacarb, disulfoton, DNOC, empenthrin, endosulfan, EPN, esfenvalerate, ethiofencarb, ethion, etofenprox, fenobucarb, fenoxycarb, fensulfothion, fipronil, flucycloxuron, flufenprox, flufenoxuron, fonofos, formetanate, formothion, fosmethilan, furathiocarb, heptachlor, hexaflumuron, hydramethylnon, hydrogen cyanide, hydroprene, IPSP, isazofos, isofenphos, isoprothiolane, isoxathion, iodfenphos, kadethrin, lindane, malathion, mecarbam, mephosfolan, mercurous, chloride, metam, Metarthizium, anisopliae, methacrifos, methamidophos, methidathion, methiocarb, methoprene, methoxychlor, methyl isothiocyanate, metholcarb, mevinphos, monocrotophos, naled, Neodiprion sertifer NPV, nicotine, omethoate, oxydemeton-methyl, pentachlorophenol, petroleum oils, phenothrin, phenthoate, phorate.

Herbicides: acetochlor, acifluorfen, aclonifen, acrolein, alachlor, alloxydim, ametryn, amidosulfuron, amitrol, ammonium sulfate, anilofos, asulam, atrazine, aziprotryn, benazolin, benfluralin, benfuresate, bensulfuron, bensulide, benztazone, chloridazon, chlorimuron, chloromethoxyfen, chloronitrofen, chloroacetic acid, chloropicrin, chlorotoluron, chlooxuron, chloroprepham, chlorosulfuron, chlorothal, chlorothiamide, cinmethyline, cinosulfuron, clethodim, clomazone, clomeprop, clopyralid, cyanamide, cyanazine, cycloate, cycloxydim, benzofencap, benzthiazuron, bifenox, bilanafos, borax, bromacil, bromobutide, bromofenoxim, bromoxynil, butachlor, butamifos, butanachlor, butralin, butylate, carbetamide, CGA 184927, chloramben, chlorobromuron, chlorobufam, chloroflurenol, difenoxuron, difenzoquat, diflufenican, dimefuron, dimepiperate, dimethachlor, dimethametryn, dimethipin, dimethylarsenic acid, dinitramin, dinoseb acetate, dinoseb, dinoterb, diphenamide, dipropetryn, diquat, dithiopyr, diuron, DNOC, PPX-A788, 2,4-D, daimuron, dalapon, dazomet, 2,4-DB, desmedipham, desmetryn, dicamba, dichlobenil, dichloroprop, dichloroprop-P, diclofop, diethatyl, flamprop-M, flazasulfuron, fluazifop, fluazifop-P, fluchloralin, flumeturon, fluoroglycofen, fluoronitrofen, flupropanate, flurenol, fluridon, fluorochloridon, fluroxypyr, fomosafen, fusamin, furyloxyfen, glufosinate, glyphosate, haloxyfop, hexazinon, imazamethabenz, imazapyr, imazaquin, imazethapyr, ioxynil, isopropalin, isoproturon, isouron, isoxaben, isoxapyrifop, lactofen, lenacil, linuron, LS830556, MCPA, pebulat, pendimethalin, pentachlorophenol, pentanochlor, mineral oil fractions, phenmedipham, picloram, piperophos, pretilachlor, primisulfuron, prodiamin, proglinazin, prometon, prometryn, propachlor, propanil, propaquizafop, propazir, propham, propyzamide, prosulfocarb, pyrazolynate, pyrazosulfuron, pyrazoxyfen, pyributicarb, pyridat, quinclorac, quinmerac, quinoclamin, quizalofop, quizalofop-P, S-23121, DPX-E96361, DSMA, eglinazine, endothal, epsorcarb, EPTC, ethalfluralin, ethidimuron, ethofumesate, fenoxaprop, fenoxaprop-P, lemon, flamprop, irgarol 1051, MCPA-thioethyl, MCPB, mecoprop, mecoprop-P, mefenacet, mefluidid, metam, metamitron, metazachlor, methabenzthiazuron, methazole, methoprotryn, methyldymron, methyl isothiocyanate, metobromuron, metolachlor, metoxuon, metribuzin, metsulfuron, molinate, monoalid, monolinuron, MSMA, naproanilide, napropamide, naptalam, neburon, nicosulfuron, nipyraclofen, norflurazon, orbencarb, oryzalin, oxadiazon, oxyfluorfen, paraquat, prometryn, simetryn, SMY 1500, sodium chlorate, sulfometuron, tar oils, TCA, tebutam, tebuthiuron, terbacil, terbumeton, terbuthylazine, terbutryn, thiazafluron, thifensulfuron, thiobencarb, thiocarbazil, tioclorim, tralkoxydim, tri-allate, triasulfuron, tribenzuron, triclopyr, tridiphane, trietazine, trifluralin, UB1-C4874, vernolate. Molluscicides: Fentin acetate, metaldehyde, methiocarb, niclosamide, thiodicarb, trimethacarb. Algicides: copper sulphate, dichlororphen, endothal, fentin acetate, quinoclamine. Additional biocides that are described in R. Gachter and H. Muller, Hamer Verlag, 3^{rd} edition, 1990, pages 791-809 can also be selected for the purposes of the application as a second biocide.

In accordance with one aspect, a synergistic biocide concentrate composition which is capable of exhibiting enhanced microbicidal activity comprising a mixture of trihalomethyl-thio-phthalimide and a second biocide which is effective at relatively low concentrations is provided. Particularly useful synergistic biocide combinations employed in the present biocide concentrate composition include, but are not limited to, Folpet/N-butyl-1,2-benzisothiazolin-3-one (BBIT), Folpet/4,5-dichloro-n-octyl-4-isothiazolin-3-one (DCOIT), Folpet/triclosan, Folpet/2-methyl-4-isothiazolin-3-one (MIT), Folpet/1,2-Benzisothiazolin-3-one (BIT), Folpet/5-Chloro-2-methyl-4-isothiazolin-3-one (CMIT), Folpet/2-Octyl-4-isothiazolin-3-one (OIT), Folpet/3-iodo-2-propynylbutyl-carbamate (IPBC), Folpet/oxyfluorfen, Folpet/3-iodopropynyl carbamate (IPC), Folpet/3-iodopropynyl-N-phenyl carbamate (IPPC), Folpet/thiabendazole, Folpet/terbutryn, Folpet/zinc pyrithione (ZnPy), Folpet/bronopol, Folpet/diruon, Folpet/Silver, Folpet/dehydroacetic acid (DHA), Folpet/dazomet and/or Folpet/carbendazim. Particularly useful biocide combinations include Folpet/IPBC, Folpet/OIT and Folpet/Thiabendazole (TBZ).

According to certain aspects of the present application, the wt. ratio of (i) trihalomethyl-thio-phthalimide (ii) a second biocide may be in the range of about 1:1 to about 10:1. Particularly useful ratios include 1:1, 2:1, 3:1 and/or 4:1.

According to one embodiment, the required amount of biocide concentrate composition can be incorporated in various end-use applications. In particular, the concentrate can be used to protect various polymer matrices. In accordance with certain embodiments, the biocide concentrate composition may be incorporated into a polymer matrix in a wt, ratio of about 1 to 10 concentrate to 99 to 10 polymer matrix. For example, the polymer matrix may be selected from the group including, but not limited to, polyolefin, polyacrylate, polymethacrylate, polyvinyl chloride, halogen-containing polymer, polyurethane, saturated or unsaturated polyester, a polymer derived from unsaturated alcohols and amines or from their acyl derivatives or acetals, a homo or copolymer of cyclic ethers, polyacetal, polyphenylene oxide or polyphenylene sulfide, polyamide or copolyamide, a phenol-formaldehyde resin, an epoxy resin or an aminoplastic resin, wood-plastic composite, polycarbonate, elastomer, rubber, acrylic, nylon, fluorocarbon, a polystyrene alone or mixtures thereof. Specific examples of selected polymeric materials are provided below:

Polymers of Monoolefins and Dioefins: According to the present application, non-limiting examples of polymers of monoolefin or diolefin include polypropylene, polyisobutylene, polybut-1-ene, poly-4-methylpent-1-ene, polyisoprene, polybutadiene, cyclopentene, norbornene, polyethylene (optionally crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE). Also, mixtures of the above mentioned polymers, for example mixtures of polypropylene with polyisobutylene, polypropylene with polyethylene (for example PP/HDPE, PP/LDPE) and mixtures of different types of polyethylene such as LDPE/HDPE. Other examples include copolymers of monoolefins and diolefins among themselves or with other vinyl monomers such as ethylene/propylene copolymers, linear low density polyethylene (LLDPE) and mixtures thereof with low density polyethylene (LDPE), propylene/but-l-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and of their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with other polymers, such as polypropylene/ethylene-propylene copolymers, LDPE/ethylene-vinyl acetate copolymers (EVA), LDPE/ethylene-acrylic acid copolymers (EM), LLDPE/EVA, LLDPE/EAA and alternating or random polyalkylene/carbon monoxide copolymers and mixtures thereof with other polymers, for example polyamides.
Hydrocarbon resins: hydrogenated modifications thereof and mixtures of polyalkylenes and starch.
(ii) Polystyrenes: (i) Poly(p-methylstyrene), poly(α-methylstyrene), high-impact polystyrenes, bextrene, polystyrene-polyisoprene-polystyrene block copolymer. (ii) Copolymers of styrene or α-methylstyrene with dienes or acrylic derivatives, for example styrene/butadiene, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene. (iii) Graft copolymers of styrene or α-methylstyrene, for example styrene on polybutadiene, styrene on polybutadiene-styrene or polybutadiene-acrylonitrile copolymers; styrene and acrylonitrile/methacrylonitrile on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers revealed in (ii), for example the copolymer mixtures known as ABS, MBS, ASA or AES polymers.
(iii) Halogen-containing polymers: Polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo and copolymers, especially polymers of halogen-containing vinyl compounds, for example polyvinyl chloride, polyvinylidene chloride, polyvinyl fluoride, polyvinylidene fluoride, in addition copolymers thereof such as vinyl chloride/vinylidene chloride, vinyl chloride/vinyl acetate or vinylidene chloride/vinyl acetate copolymers.
(iv) α,β-Unsaturated acid based polymers and its derivatives: (i) Polyacrylates and polymethacrylates; polymethyl methacrylates, polyacrylamides and polyacrylonitriles, impact-modified with butyl acrylate. (ii) Copolymers of the monomers mentioned under (i) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
(v) Unsaturated alcohols/Amines/Acyl/Acetals based polymers: Polyvinyl alcohol, polyvinyl acetate, polyvinyl stearate, polyvinyl benzoate, polyvinyl maleate, polyvinyl butyral, polyallyl phthalate or polyallyl melamine; additionally their copolymers with olefins such as polypropylene, polyisobutylene, polybut-1-ene, poly-4-methylpent-1-ene, polyisoprene or polybutadiene, cycloolefins, polyethylene, for example HDPE, HDPE-HMW, HDPE-UHMW, MDPE, LDPE, LLDPE, VLDPE and ULDPE.
(vi) Cyclic ethers: Homopolymers and copolymers of cyclic ethers for example polyalkylene glycols, polyethylene oxide, polypropylene oxide or copolymers thereof with bisglycidyl ethers.
(vii) Polyacetals: Polyoxymethylene comprising ethylene oxide as a comonomer; polyacetals modified with thermoplastic polyurethanes, acrylates or methacrylate-butadiene-styrene (MBS).
(viii) Polyurethane (PUR): Polyurethanes are produced by the polyaddition reaction of a polyisocyanate with a polyalcohol (polyol) in the presence of a catalyst and other additives. It is derived preferably from hydroxyl-terminated polyethers, polyesters or polybutadienes on the one hand and aliphatic or aromatic polyisocyanates on the other, as well as precursors thereof.
(ix) Polyamides and copolyamides: These polymers are derived from diamines and dicarboxylic acids and/or from aminocarboxylic acids or the corresponding lactams, such as polyamide 4, polyamide 6, polyamide 6/6, 6/10, 6/9, 6/12, 416, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with (Ethylene propylene diene monomer) EPDM or acrylonitrile-butadiene-styrene (ABS); and polyamides condensed during processing.
(x) Polyesters: (i) Polyesters derived from dicarboxylic acids and dials and/or from hydroxycarboxylic acids or the corresponding lactones, for example polyethylene terephthalate, polybutylene terephthalate, poly-1,4-dimethylolcyclohexane terephthalate and polyhydroxybenzoates, as well as block copolyether esters derived from hydroxyl-terminated polyethers; and also polyesters modified with polycarbonates or MBS. (ii) Unsaturated polyesters those are derived from anhydrides or acids of aromatic, saturated and unsaturated aliphatic dicarboxylic acids and from aromatic, saturated and unsaturated aliphatic diols such as fumaric acid, maleic acid, maleic anhydride, phthalic anhydride, isophthalic anhydride, terephthalic acid, adipic acid, ethylene glycol, propanediol, butanediol, neopentyl glycol, bisphenol A, bisphenol F, butenediol, etc. Curing of the unsaturated polyesters is carried out radically in a crosslinking copolymerization with vinyl monomers such as styrene, p-methylstyrene, α-methylstyrene, methyl methacrylate, acrylic acid, methyl acrylate, acrylonitrile, and mixtures of these monomers.
(xi) Natural polymers: Cellulose, rubber, gelatin and chemically modified homologous derivatives thereof, for example cellulose acetates, cellulose propionates and cellulose butyrates, or the cellulose ethers such as methyl cellulose; as well as resins and their derivatives.
(xii) Polymer blends: Blends of the aforementioned polymers such as PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PANHDPE, PA/PP, PA/PPO, PBT/PC/ABS or PBT/PET/PC.
(xiii) Other Polymers: (i) Polyphenylene oxides and sulfides, and mixtures of polyphenylene oxides with styrene polymers or polyamides; (ii) Polycarbonates and polyester carbonates; (iii) Crosslinked polymers derived from aldehydes on the one hand and from phenols, ureas or melamines on the other hand, such as phenol-formaldehyde, urea-formaldehyde and melamine-formaldehyde resins; and (iv) Epoxy resins are derived from di and polyfunctional epoxides which are crosslinked with polyamines, for example diethylenetriamine, triethylenetetramine, tetraethylenepentamine, methylenedianiline, diaminodiphenylsulfone and polyaminoamides or with dicarboxylic acids and their anhydrides, like hexahydrophthalic anhydride, phthalic anhydride, pyromellitic anhydride, methylnadic anhydride.

According to the some aspects of the present application, an antioxidant agent may be included as part of the biocide concentrate composition. The antioxidant containing biocide composition is employed in the preparation of any of the above listed industrial polymeric matrices to afford anti-microbicidal effects, and the presence of the antioxidant agent may allow the biocide to withstand high processing temperatures of about 280° C. as well as prevent the discoloration of the polymer matrix. The suitable antioxidants for the present biocide concentrate composition would include but are not limited to the following list of antioxidant agents:
(i) Alkylated monophenols: 2,6-di-tent-butyl-4-methylphenol, 2-tent-butyl-4,6-di-methylphenol, 2,6-di-tent-butyl-4-ethylphenol, 2,6-di-tent-butyl-4-n-butylphenol, 2,6-di-tert-butyl-4-isobutylphenol, 2,6-dicyclopentyl-4-methylphenol, 2-(α-methylcyclohexyl)4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, such as 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
(ii) Alkylthiomethylphenols: 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol;
(iii) Hydroquinones and alkylated hydroquinones: 2,6-di-tent-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate;
(iv) Tocopherols: α-tocopherol, β-tocopherol, γ-tocopherol, δ-tocopherol and mixtures thereof;
(v) Hydroxylated thiodiphenyl ethers: for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;
(vi) Alkylidenebisphenols: 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tent-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis-(2,6-d i-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n -dodecylmercaptobutane, ethylene-glycol-bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane;
(vii) O-, N- and S-benzyl compounds: 3,5,3′,5′-tetra-tert-butyl-4,4′-dihydroxydibenzyl-ether, octadecyl-4-hydroxy-3,5-dimethylbenzyl-mercaptoacetate, tridecyl-4-hydroxy-3,5-di-tert-butylbenzyl-mercaptoacetate, tris(3,5-di-tert-butyl-4-hydroxybenzyl)amine,bis(4-tert-butyl-3-hydroxy-2,6-dimethylbenzyl)-dithio-terephthalate, bis(3,5-di-tert-butyl-4-hydroxybenzyl)sulfide, isooctyl-3,5-di-tert-butyl-4-hydroxybenzylmercaptoacetate;
(viii) Hydroxybenzylated malonates: Dioctadecyl-2,2-bis(3,5-di-tert-butyl-2-hydroxybenzyl)malonate, di-octadecyl-2-(3-tert-butyl -4-hydroxy-5-methylbenzyl)malonate, didodecyl-mercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
(ix) Aromatic hydroxybenzyl compounds: 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
(x) Triazine compounds: 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate;
(xi) Benzylphosphonates: Dimethyl-2,5-di-tert-butyl-4-hydroxybenzylphosphonate, diethyl-3,5-di-tert-butyl-4-hydroxybenzyl-phosphonate, dioctadecyl-3,5-di-tert-butyl-4-hydroxybenzyl-phosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid;
(xii) Acylaminophenols: 4-hydroxylauranilide, 4-hydroxystearanilide, octyl N-(3,5-di-tert-butyl-4-hydroxyphenyl)carbamate;
(xiii) Esters: (a) The esters of β-(3,5-di-tent-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; (b) The esters of β-(5-tert-butyl-4-hydroxy-3-methylphenyl)propionic acid with mono or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; (c) The esters of β-(3,5-dicyclohexyl-4-hydroxyphenyl)propionic acid with mono or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; (d) The esters of 3,5-di-tert-butyl-4-hydroxyphenyl acetic acid with mono or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; (e) The amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-d i-tert-butyl-4-hydroxyphenylpropionyl)-hydrazide, N,N′-bis[2-(3,5-di-tert-butyl-4-hydroxyphenyl]propionyloxy)ethyl]oxamide (Naugard®XL-1 supplied by Uniroyal); (xiv) Ascorbic acid (vitamin C);
(xiv) Aminic antioxidants: N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p -phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyidiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, such as p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N,N′-tetramethyl-4,4′-diaminodiphenylmethane, 1,2-bis [(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono and dialkylated tert-butyl/tert-octyldiphenylamines, a mixture of mono and dialkylated nonyldiphenylamines, a mixture of mono and dialkylated dodecyldiphenylamines, a mixture of mono- and dialkylated isopropyl/isohexyldiphenylamines, a mixture of mono- and dialkylated tert-butyldiphenylamines, 2,3-dihydro -3,3-dimethyl-4H-1,4-benzothiazine, phenothiazine, a mixture of mono and dialkylated tert-butyl/tert-octylphenothiazines, a mixture of mono and dialkylated tert-octyl-phenothiazines, N-allylphenothiazine, N,N,N,N′-tetraphenyl-1,4-diaminobut-2-ene, N,N-bis(2,2,6,6-tetra-methyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

Particularly useful antioxidants include tetrabismethylene-(3,5-di-t-butyl-4-hydroxyhydrocinnamate)methane, octadecyl-3(3,5-di-t-buty!-4-hydroxyphenyl)-propionate, C₁₃-C₁₅ linear and branched alkyl esters of 3-propionic acid, 2,2-thioethylene bis propionate, 1,3,5-tris isocyanurate, 1,3,5-trimethyi-2,4,6-tris-benzene, 2,2-methylenebis phenol, 4,4-butylidenebis phenol, 2,2-isobutylidenebis phenol, 2,5-di-t-amylhydroquinone, α,α3-tris butane, 1,3,5-tris-1,3,5-triazone-2,4,6-trione, polymeric sterically hindered phenol, triethylene glycol bis propionate, n,n-hexamethylene bis propionamide, 4,4-thiobis phenol, 2,2-methylenebis phenol, 1,2-bis hydrazine or tris phosphate bis pentaerythritoi diphosphate alone or in combination. However, the most preferred antioxidant for the present application is selected from the group consisting of but are not limited to 1,3,5-tris(3,5-di-t-butyl-4-hydroxybenzyl)isocyanurate, 1,3,5-trimethyl-2,4,6-tris-(3,5-d i-tert-butyl-4-hydroxybenzyl)benzene, 2,2,methylenebis(6-t-butyl -4-methyl phenol), 4,4 butylidenebis(2-t-butyl-5-methylphenol), 2,5-di-t-amylhydroquinone, 1,1,3-tris (2′methyl-4′-hydroxy-5′-t-butylphenyl)butane, 1,3,5 tris-(4-tert-butyl-3-hydroxy-2-6-dimethylbenzyl)1,3,5 triazine-2,4,6-(1H,3H,5H)-trione, 4,4′-thiobis(2-t-butyl-5-methylphenol)octadecyl-3 (3′,5′-di-tert-butyl-4-hydroxyphenyl)propionate (PP-18) and/or tris-(2,4-di-tertbutyl phenyl)phosphate (Alkanox 240). Further, the level of antioxidant used in the present biocide concentrate composition differs with respect to the kind of polymer wherein it is employed. However, in accordance with certain aspects the wt. ratio of biocide to antioxidant may be in the range of about 1:0.5 to 1:3, wherein the amount of biocide would include the combination of the first and second biocides.

In accordance with one embodiment, a carrier for the present concentrated composition is provided. The carrier may be selected from the group including, but not limited to, plastic, wax and/or plasticizer and wherein the selected carrier can be liquid or solid in nature.

The plasticizers which can be used must be compatible with the polymer composition with which they are to be mixed. This can be achieved by the selection of known plasticizers for the polymer which is to be protected from microbiocidal attack. An adequate amount of the plasticizer may be employed to act as a carrier material for the microbiocide. The exact amount of plasticizer required will depend upon the type and concentration of the microbiocide as well as the types and amounts of other additives which may be present in the concentrate. Usually, an excess of the minimum amount of plasticizer will be employed in the concentrate in order to ensure that the toxicity level remains low. The most widely used plasticizers are phthalates and esters of polycarboxylic acids with linear or branched aliphatic alcohols of moderate chain length. Plasticizers work by embedding themselves between the chains of polymers and spacing them apart and thereby increasing the “free volume”, and thus significantly lowering the glass transition temperature for the plastic and making it softer. Suitable plasticizers for the purposes of the present application would include, but are not limited to, Bis(2-ethylhexyl)phthalate (DEHP), Diisononyl phthalate (DINP), Bis(n-butyl)phthalate (DnBP, DBP), Butyl benzyl phthalate (BBzP), Diisodecyl phthalate (DIDP), Di-n-octyl phthalate (DOP or DnOP), Diisooctyl phthalate (DIOP), Diethyl phthalate (DEP), Diisobutyl phthalate (DIBP), Di-n-hexyl phthalate, Trimethyl trimellitate (TMTM), Tri-(2-ethylhexyl)trimellitate (TEHTM-MG), Tri-(n-octyl, n-decyl)trimellitate (ATM), Tri-(heptyl,nonyl)trimellitate (LTM), n-octyl trimellitate (OTM), Bis(2-ethylhexyl)adipate (DEHA), Dimethyl adipate (DMAD), Monomethyl adipate (MMAD), Dioctyl adipate (DOA), Sebacate-based plasticizer, Dibutyl sebacate (DBS), Dibutyl maleate (DBM), Diisobutyl maleate (DIBM), Benzoates, Epoxidized vegetable oils, N-ethyl toluene sulfonamide, N-(2-hydroxypropyl)benzene sulfonamide (HP BSA), N-(n-butyl) benzene sulfonamide (BBSA-NBBS), Tricresyl phosphate (TCP), Tributyl phosphate (TBP), Triethylene glycol dihexanoate (3G6, 3GH), Tetraethylene glycol diheptanoate (4G7), Polymeric plasticizers, Polybutene, Acetylated monoglycerides, Alkyl citrates, Triethyl citrate (TEC), Acetyl triethyl citrate (ATEC), Tributyl citrate (TBC), Acetyl tributyl citrate (ATBC), Trioctyl citrate (TOC), Acetyl trioctyl citrate (ATOC), Trihexyl citrate (THC), Acetyl trihexyl citrate (ATHC), Butyryl trihexyl citrate (BTHC), Trimethyl citrate (TMC) or Aalkyl sulphonic acid phenyl ester (ASE), C₁₆-C₂₂ fatty alcohols, C₈-C₂₂ fatty acids, stearic acid, 1-hexadecanol, 1-octadecanol, 1-tetradecanol, chlorinated paraffinic hydrocarbons and polyethylene glycols alone or in combination.

In accordance with one embodiment, phthalate-free plasticizers are employed to prepare the polymer composition. The phthalate-free plasticizers for the present application may be selected from the group including, but not limited to, ether-ester compounds, glycerin triesters, glyceryl-1,2-bisbutanoate-benzoate, glyceryl-1,3-bisbutanoate-benzoate, glyceryl-1,2-bisbenzoate-butanoate, glyceryl-1,3-bisbenzoate-butanoate, isocyanurates, esters of an anhydrosugar alcohol, aryl phosphates, phenol alkanesulphonates, dipropylene glycol dibenzoate, di(isonyl)cyclohexane dicarboxylate, diisonyl adipate, C₈-C₁₈ alkyl pyrrolidones, epoxidized soyabean oil, epoxidized linseed oil alone or in combination.

In a particularly useful embodiment, there is provided a biocide concentrate composition of a folpet analogue and a second biocide, which is capable of inhibiting or killing grain (+)/gram (−) bacterial strains or fungal strains in a synergistic manner with a lower concentration of selected biocidal actives. The specific gram (+) and gram (−) bacterial strains include, but are not limited to the following list of genus Actinobacteria, Actinomyces, Bacillales, Bacillus, Clostridium, Corynebacterium, Enterococcus, Lactobacillales, Listeria, Nocardia, Propionibacterium, Rhodococcus equi, Sarcina, Solobacterium, Staphylococcus, Streptococcus, Acetic acid bacteria, Acinetobacter, Bacteroides, Bdellovibrio, Coxiella, Cyanobacteria, Cytophaga, Enterobacter, Enterobacteriaceae, Escherichia, Fusobacterium, Haemophilus, Helicobacter, Klebsiella, Legionella, Leptotrichia, Moraxella, Neisseria, Proteobacteria, Proteus, Pseudomonas, Rickettsia, Salmonella, Serratia, Shigella, Spirochaete, Stenotrophomonas, Typhus, Vampirococcus, Verminephrobacter, Vibrio, Wolbachia. The preferred bacterial genus are Actinobacteria, Staphylococcus, Escherichia, Salmonella, Shigella, Enterobacteriaceae, Pseudomonas, Moraxella, Helicobacter, and/or Legionella. Further, the examples of fungi to which, the compositions of the present application are applicable include but are not limited to: Alternaria alternata, Aspergillus flavus, Aspergillus terreus, Aspergillus fumigatus, Aspergillus repens, Aspergillus versicolor, Candida albicans, Chaetomium globosum, Cladosporium cladosporioides, Cladosporium herbarum, Cladosporium sphaerospermum, Coniophora puteana, Curvularia genticulata, Diplodia natalensis, Epidermophytonfloccosum, Fusarium oxysporum, Gliocladium virens, Gloeophyllum trabeum, Humicola grisea, Lecythophora mutabilis, Lentinus cyaihiformis, Lentinus lepidus, Memnionella echinata, Mucor indicus, Mucor racemosus, Oligoporus placenta, Paecilomyces Penicillium citrimun, Penicillium funiculosum, Penicillium ochrochloron, Penicillium purpurogenum, Penicillium pinophilum, Penicillium variabile, Petriella setifera, Phanerochaete chrysosporium, Phoma violacea, Poria placenta, Rhodotorula rubra, Schizophyllum commune, Sclerophoma phytiophila Scopulariopsis brevicaulis, Serpula laaymans, Sporobolomyces roseus, Stemphyliwn dendriticum, Trichophyton mentagrophytes, Tichurus Trichophyton rubruni, Ulocladium altrum and Ulocladium chartarum. Of which particularly interested fungal strains are Alternaria alternata, Alternaria tenuissima, Aspergillus niger, Aspergillus versicolor, Aureobasidium pullulans, Chaetomium globosum, Cladosporium cladosporioides, Coniophora puteanct, Gloeophyllum trabeum, Memnionella echinata, Mucor indicus, Oligoporus placenta, Penicillium citrimum, Penicillium chrysogenum, Penicillium funiculosum, Penicillium pinophilum, Sclerophoma phytiophila, Stachybotrys atra, Stachybotrys chartarum, and Ulocladium chartarum. The most preferred bacterial and fungal strains that can be inhibited or killed by the present biocide composition are Staphylococcus aureus, Klebsiella pneumonia, Pseudomonas areuginosa, Bacillus subtilus, Aspergillus niger, Aspergillus flavus, Oscillatoria tenius, Penicillin funiculosum, Chaetomium globosum, Aureobasidium pullulans, Trichoderma virens and/or Streptoverticillium reticulum.

An ultraviolet light absorber is optionally employed in the present biocide concentrate composition. Examples of ultraviolet light absorbers include, but are not limited to, one or more of the following materials 2-(2′-Hydroxyphenyl)benzotriazoles: 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chloro-benzotriazole, 2-(3′-sec-butyl-5′-tert-butyl-2′-hydroxy-phenyl)benzotriazole, 2-(2′-hydroxy4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the trans-esterification product of 2-[3′-tert-butyl-5′-(2-methoxycarbonylethyl)-2′-hydroxyphenyl]-2H-benzotriazole with polyethylene glycol 300; [R——CH₂CH₂CH₂——COO——CH₂——]₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole; 2-Hydroxbenzophenones: 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives; Esters of substituted and unsubstituted benzoic acids: 4-tertbutyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; Acrylates: ethyl-α-cyano-β,β-diphenylacrylate, isooctyl-α-cyano-β-diphenylacrylate, methyl α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline; Nickel compounds: nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands; Sterically hindered amines: bis(2,2,6,6-tetramethyl-4-piperidyl)sebacate, bis(2,2,6,6-tetramethyl-4-piperidyl)succinate, bis(1,2,2,6,6-pentamethyl-4-piperidypl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis-(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro-[4,5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4,5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro-[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, (2,2,6,6-tetramethyl-4-piperidyl)hexamethylenediamine, diester of -4-methoxy-methylenemalonic acid with 1,2,2,6,6-pentamethyl-4-hydroxypiperidine, poly[methylpropyl-3-oxy-4-(2,2,6,6-tetramethyl-4-piperidyl]siloxane, reaction product of maleic acid anhydride-α-olefin-copolymer with 2,2,6,6-tetramethyl-4-aminopiperidine or 1,2,2,6,6-pentamethyl-4-aminopiperidine; Oxamides: 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tent-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides; Triazines: 2-(2-Hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis (4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

The compositions described herein may also include various optional additives. Examples of specific additives include nucleating agents, antiblocking agents, basic co-stabilizers, blowing agents, fillers and reinforcing agents, light stabilizers and UV inhibitors, metal inhibitors, surfactants, intercalates, lactones, compatibilizers, coupling agents, impact modifiers, chain extenders, colorants, dyes, pigments, lubricants, emulsifiers, antistatic agents, dispersants, metallic salts of fatty acids, processing aids, additional antioxidants, synergists, fluorescent whiteners, fire retardants, abrasives or roughening agents such as diatomaceous earth, cross linking agents, foaming agents, thermal stabilizers, radiation stabilizers, mold release additives, ignition resistant additives plasticizers, flow enhancers, anti-fogging agents, wood, wood flour and/or slip agents and the like. These optional additives and their matching quantities can be selected according to particular requirements for the product. Integration of these optional additives to the polymeric material can be accomplished by suitable methods that are known in the prior art.

Suitable colorants include, inorganic pigments, for example, copper, ferrous/ferric oxide, ferric oxide, titanium dioxide, chrome titanate, titanium yellow, cobalt blue, ultramarine blue, copper chromite, molybdates, manganese ferrite, chromium hematite, cobalt-zinc aluminate, zinc oxide, carbon black, zinc sulfide, graphite, calcium carbonate, hydrated aluminum silicate, copper powder, napthol red, benzimidazole, phthalocyanine greens, phthalocyanine blues, isoindolinones, dioxazines, bisdioxazines, quinacridones and the like. Suitable flake pigments include bright aluminum flake, extremely fine aluminum flake, medium particle size aluminum flake, bright medium coarse aluminum flake, and mica flake coated with titanium dioxide pigment also known as pearl pigments. The colorants can be added to the composition in amounts ranging between about 0.5 wt. % to about 3 wt. %, or in amounts ranging between about 0.4 wt. % to about 2.0 wt. %, based on the overall weight of the composition.

Antistatic agents for the present application can be selected from hygroscopic compounds which can absorb moisture from the adjacent environmental air, and can create a conductive layer of moisture on the polymer surface that disperses the charge. Non-limiting examples of antistatic agents would include quaternary ammonium compounds and amines and their associated derivatives, phosphate and fatty acid esters, polyhydric alcohol derivatives, sulfated waxes, alkoxylated aliphatics and aromatics.

The biocide concentrate composition of the present application can include fillers and extenders for example, oxides of inorganic metals, particularly, Mg, Al, Si, and Ti. Also, the proteins derived from sunflower, soybean, cotton seed, peanut, blood, egg, rape seed and acetylated derivatives thereof, gelatin, cross-linked gelatin, vinylacetate, and acylated proteins may be included in the composition.

Further, lubricants can be added to the biocide concentrate composition of the present application in order to improve the flow characteristics of the plastic or polymer matrix employed therein. Polarity, melting point, and solubility in the polymer matrix are key factors when a lubricant is selected. The primary classes of lubricants include amides, esters, metallic stearates, waxes, and acids. Exemplary lubricants of the present application would include but are not limited to lipids, glycerides, wax, fatty acids, fatty acid salts, stearates of Al, Ca, Mg, and tin, magnesium silicate, silicones and the like. For example, to enhance the flow properties of the polymer matrices, animal or vegetables fat based lipids can be used.

Blowing agents from physical and chemical origin may also be employed in the production of the compositions described herein. Gasses likes N₂, CO₂, O₂, or low-boiling liquids such as short-chain hydrocarbons, may be dissolved in the polymeric matrix and can be volatilized by the release of pressure or the heat of processing. Chemical blowing agents are solids or liquids that generate gasses when decomposed by the heat of processing. Chemical blowing agents can be designed to decompose within well-defined temperature ranges that can be lowered by the addition of activating compounds. The examples of blowing agents useful in the present application include but are not limited to azodicarbonamide, dinitropentamethylene tetramine, benzene sulfonyl hydrazide, p-toluene sulfonyl hydrazide, p,p-oxybis(benzene sulfonyl hydrazide), 5-phenyl tetrazole, and sulfonyl semicarbazides.

The biocide concentrate composition prepared according to the present application can be employed in various fields including but not limited to floral, industrial, agricultural, medical, dental and/or veterinary. The level of biocide concentrate used in various end-use applications may be from about 0.01 wt. % to 0.75 wt. %, more particularly from about 0.075 wt. % to about 0.6 wt. % of the total composition.

Non-limiting examples for typical end-use applications would include extruded and non-extruded face fibers for area rugs, carpet backing, latex adhesive backings used in carpet. Additionally, the biocide concentrate of the present application can be used with melt-processed polymers in the field of liquid filtration media, non-woven air filtration media; outdoor fabrics such as woven and non-woven car and boat covers, tarps, tents, canvas, ducking, sails, ropes, pool covers, umbrellas, awnings, seating, camping gear and geotextiles, drywall, weather stripping, insulation, housewrap and roof wrap, wall covering fabrics; flooring materials such as cement, concrete, mortar and tile, synthetic marble for kitchen and bath counters and sinks, sanitary ceramic composites, toilets, shower stalls and curtains; sealing materials such as adhesives for plumbing and packaging, glazing for windows, tile and vitreous china, grout, push buttons for elevators, handrails for stairs, mats, and knobs, industrial equipment such as tape, tubing, barrier fabrics, conveyor belts, insulators and insulation for wire and cable, plumbing supplies and fixtures, gaskets, collection and storage equipment such as including piping systems, silos, tanks and processing vessels and coatings used on the inside of fire system sprinkler pipes; daily necessities such as chopping boards, disposable gloves, bowls, kitchen drain baskets, kitchen refuse baskets, kitchen knife handles, chopsticks, tableware, table cloths, napkins, trays, containers, bags, lunch boxes, chopstick cases, dusters, sponges, brooms, mops, wipes, bathroom stools, washbowls, pales, cupboards, soap cases, shampoo holders, toothbrush holders, toothbrushes, razor blade handles, wrapping films, food wraps and packaging, canteens, emergency water tanks, toilet seats, hairbrushes, brush bristles, combs, scrubbers, tools and tool handles, cosmetics and cosmetic containers, and clothing. Various other contemplated uses include stationery and writing materials such as mechanical pencils, ball-point pens, pencils, erasers, floppy disk cases, clipboards, clear paper holders, fancy cases, video tape cases, photo-magnetic disk shells, compact disk cases, desk mats, binders, book covers, writing paper and pocket books, automobile parts for example, a steering wheels, armrests, panels, shift knobs, switches, keys, door knobs, assist grips, truck liners, convertible tops and interior liners, appliances such as refrigerators, washing machines, vacuum cleaners and bags, air conditioners, clothing irons, humidifiers, dehumidifiers, water cleaners, dish washers and dryers, rice cookers, stationary and mobile telephones, copiers, touch panels for ATM or retail kiosks, textile products such as socks, pantyhose, undergarments, inner liners for jackets, aprons, gloves and helmets, towels, bathing suits, toilet covers, cushion pads, curtains, carpet fibers, fiberfill for quilts and pillows, pillows, sheets, blankets, bedclothes, bedding, mattress ticking, sleeping bags, mattress cover pads and filling, pillow covers, nose and mouth masks, towels, caps, hats, wigs, etc. goods related to public transportation such as overhead straps, handles and grips, levers, seats, seat belts, luggage and storage racks sporting goods such as balls, nets, pucks, whistles, mouth pieces, racket handles, performance clothing, protective gear, helmets, indoor and outdoor artificial turf, shoe linings and reinforcements, tools, structures and ceremonial objects used in athletic events and the martial arts, medical applications such as bandages, gauze, catheters, artificial limbs, implants, instruments, scrubs, facemasks, shields, reusable and disposable diapers, sanitary napkins, tampons, condoms, uniforms, gowns and other hospital garments, musical instruments such as in reeds, strings and mouthpieces, contact lens, lens keepers and holders, plastic credit/debit cards, sand-like materials for play boxes, synthetic wood, wood-plastic composites (WPC), injection molding, urethane coatings, jewelry and wrist watch bands.

Further, the biocide concentrate composition described herein can be employed in end-use applications such as polymer wood composites and their related applications such as (i) construction materials such as window frames, exterior cladding, exterior siding, door frames, ducting, roof shingles and related roofline products, and exterior boardwalks and walkways; (ii) interiors and internal finishes for example, interior paneling, decorative profiles, office furniture, kitchen cabinets, shelving, worktops, blinds and shutters, skirting boards, and interior railings; (iii) automotive including door and head liners, ducting, interior panels, dashboards, rear shelves, trunk floors, and spare tire covers; (iv) garden and outdoor products such as decking, fence posts and fencing, rails and railings, garden furniture, sheds and shelters, park benches, playground equipment, and playground surfaces; (v) industrial flooring, railings, marine pilings, marine bulkheads, fishing nets, railroad ties, and pallets.

The composition of the present application can also be employed in various medical related end-use applications which include but are not limited to dressings, packings, meshes, films, filtering surfaces, filters, infusers, dental floss or sutures, containers or vials, antimicrobial complex (containing polyethylene, high density polyethylene, polyvinylchloride, latex, silicone, cotton, rayon, polyester, nylon, cellulose, acetate, carboxymethylcellulose, alginate, chitin, chitosan and hydrofibers) and in liquids, solutions, dispersions, or suspensions comprising an antimicrobial matrix, such as topical solutions, aerosols, mists, sprays, drops, infusions and instillation solutions for body cavities and tubes such as the bladder, prostate, perintheal, pericharcliar, pleural, intestinal and alimentary canal. Examples of other formulations include those that are suitable for nasal membranes, oral cavity or gastrointestinal tract, formulated with antimicrobial matrices as lozenges, toothpastes, gels, powders, coated dental implants, dental floss or tape, chewing gum, wafers, mouth washes or rinses, drops, sprays, elixirs, syrups, tablets, or capsules. Compositions may be appropriate for vaginal or rectal administration devised with an antimicrobial matrix as suppositories, dressings, packings, tampons, creams, gels, ointments, pastes, foams, sprays, and solutions for retention enemas or instillations.

Further, certain aspects of the present application are illustrated in detail by way of the following examples. The examples are given herein for illustration of the invention and are not intended to be limiting thereof.

### EXAMPLE 1

### Process for Preparing Antimicrobial Plastics or Polymeric Matrix

Plastic samples containing the biocide concentrate composition containing antioxidant can be prepared by mixing with commercially available flexible PVC and processing at 175° C. in a brabender. The samples are pressed to form coupons for testing purposes. A sample containing no biocide is also prepared to serve as a negative control against the samples of the present invention.

### EXAMPLE 2

### Fungal Resistance Test

Fungal resistance tests are conducted according to ASTM G-21. Briefly, a fungal inoculum containing a mixture of Aspergillus niger (ATCC 9642), Aureobasidium pullulans (ATCC 15233), Chaetomium globosum (ATCC 6205), Penicillium funiculosum (ATCC 11797) and Trichoderma virens (ATCC 9645) is prepared to obtain a final spore concentration of about 10⁵ spores/ml. The samples (in triplicate) are placed on Petri-dishes containing nutrient salts agar and incubated with the spore suspension. The samples are then incubated at 28° C. for 4 weeks and rated weekly. The fungal growth of the samples is rated on a scale of 0 to 4 where: 0 is no growth, 1 is traces of growth (less than 10%); 2 is light growth (10-30%); 3 is medium growth (30-60%) and 4 is maximum growth (more than 60%). The ratings shown in Tables 1 to 3 correspond to those at the end of the test i.e., on 4^{th} week for three different compositions of combination of biocidal agents.

### EXAMPLE 3

### Pink Stain Test

Pink Stain tests are conducted according to ASTM E1428. Briefly, an inoculum containing the microorganism Streptoverticillium reticulum (ATCC 25607) is prepared. The inoculum is streaked onto the surface of Yeast Malt Extract Agar. The samples (in triplicate) are placed on the inoculated agar and incubated at 28° C. for 14 days. The degree of staining is rated on a scale of 0-4 where: 0 is no stain; 1 is a trace of stain (less than 10%); 2 is light stain (10-30%); 3 is medium stain (30-50%) and 4 is maximum stain (more than 50%). The ratings of the pink stain test are disclosed in Tables 1 to 3 for three different synergistic biocide compositions.

### EXAMPLE 4

### Zone of Inhibition

Briefly a fungal inoculum containing a mixture of A. niger (ATCC 9642) and P. funiculosum (ATCC 11797) is prepared. The spore suspension is added to molten Malt agar to a final concentration of 10⁴-10⁵ spores/ml, poured onto the petri-dishes and allowed to dry. The samples are placed on the surface of the seeded agar and incubated at 28° C. for 4 weeks. A zone of inhibition around the sample is rated as “+”. The absence of zone of inhibition is rated as “−”. The results are shown in Tables 1 to 3 for three different combinations of biocidal agents.

TABLE 1
Evaluation of synergistic composition of Folpet + 3-Iodo-2-
propynylbutyl-carbamate (IPBC).

| Biocide | | Antimicrobial Activity | | |
|---|---|---|---|---|
| | Quantity | Fungal | | Zone |
| Name | (in ppm) | Resistance Test | Pink Stain | inhibition |
| No biocide | — | 4 | 4 | − |
| OBPA | 500 | 0 | 0 | + |
| Folpet | 3000 | 1 | 0 | − |
| IPBC | 500 | 1 | 2 | + |
| Folpet + IPBC | 700 + 300 | 1 | 0 | − |
| Folpet + IPBC | 910 + 390 | 0 | 0 | − |
| Folpet + IPBC | 945 + 405 | 0 | 0 | − |
| Folpet + IPBC | 980 + 420 | 0 | 0 | + |
| Folpet + IPBC | 1050 + 450 | 0 | 0 | + |
| Folpet + IPBC | 1600 + 400 | 0 | 0 | − |
| Folpet + IPBC | 1800 + 200 | 1 | 0 | − |
| Folpet + IPBC | 2700 + 300 | 1 | 0 | − |

TABLE 2
Evaluation of synergistic composition of Folpet + Thiabendazole (TBZ).

| Biocide | | Antimicrobial Activity | | |
|---|---|---|---|---|
| | Quantity | Fungal | | |
| Name | (in ppm) | Resistance Test | Pink Stain | Zone inhibition |
| No biocide | — | 4 | 4 | − |
| OBPA | 500 | 0 | 0 | + |
| Folpet | 3000 | 1 | 0 | − |
| TBZ | 500 | 1 | 2 | − |
| Folpet + TBZ | 100 + 50 | 3 | 2 | − |
| Folpet + TBZ | 200 + 50 | 3 | 2 | − |
| Folpet + TBZ | 300 + 100 | 1 | 2 | − |
| Folpet + TBZ | 300 + 200 | 1 | 1 | − |
| Folpet + TBZ | 400 + 100 | 0 | 2 | − |
| Folpet + TBZ | 400 + 200 | 0 | 1 | − |
| Folpet + TBZ | 465 + 115 | 0 | 1 | − |
| Folpet + TBZ | 500 + 200 | 0 | 1 | − |

TABLE 3
Evaluation of synergistic composition of Folpet + 2-Octyl-4-
isothiazolin-3-one (OIT).

| Biocide | | Antimicrobial Activity | | |
|---|---|---|---|---|
| | Quantity | Fungal | | |
| Name | (in ppm) | Resistance Test | Pink Stain | Zone inhibition |
| No biocide | — | 4 | 4 | − |
| OBPA | 500 | 0 | 0 | + |
| Folpet | 3000 | 1 | 0 | − |
| OIT | 500 | 1 | 1 | − |
| Folpet + OIT | 500 + 200 | 3 | 1 | − |
| Folpet + OIT | 1000 + 400 | 1 | 0 | − |
| Folpet + OIT | 2000 + 800 | 2 | 0 | − |

Evaluation in End-Use Applications

### EXAMPLE 5

### Evaluation in Swimming Pool Liner Formulation

A swimming pool liner formulation is selected. The individual and synergistic biocidal compositions respectively IPBC, Folpet, OBPA and Folpet+IPBC are added and processed in the brabender as described in Example 1. The efficacy data for each sample is tested according to ASTM G21. Growth ratings after 4 weeks are described in the following Table 4.

TABLE 4

| Biocide | | Fungal |
|---|---|---|
| Name | Quantity (in ppm) | Resistance Test |
| Control | No biocide | 3 |
| Folpet | 2000 | 1 |
| IPBC | 500 | 1 |
| Folpet + IPBC | 700 + 300 | 0 |
| OBPA | 400 | 0 |

### EXAMPLE 6

### Evaluation in Wall Covering Formulation

A wall covering formulation is employed for evaluating the efficacy of the present biocide concentrate composition. The individual and synergistic biocidal compositions respectively IPBC, Folpet, OBPA, Folpet+IPBC, and Folpet+TBZ are added and processed in the brabender as disclosed in Example 1. The efficacy data for each sample was tested according to ASTM G21. Growth ratings after 4 weeks are described in the following Table 5.

TABLE 5

| Biocide | | Fungal |
|---|---|---|
| Name | Quantity (in ppm) | Resistance Test |
| Control | No biocide | 4 |
| Folpet | 2000 | 3 |
| IPBC | 1000 | 2 |
| Folpet + IPBC | 1050 + 450 | 3 |
| Folpet + TBZ | 800 + 200 | 0 |
| OBPA | 600 | 0 |

### EXAMPLE 7

### Evaluation in Non-Woven Formulations

A non-woven formulation was employed for evaluating the efficacy of the biocide concentrate composition. A control sample containing no biocide was evaluated vs. samples containing different levels of the biocide concentrate composition (Folpet+IPBC). The efficacy data for each sample was tested according to ASTM D5590. Briefly, malt plates are inoculated with fungi to a final concentration of about 10⁵ spores/ml. Plates were incubated at 28° C./85% RH for 4 weeks. Growth on the surface of the sample is rated on a scale from “0” to “10” where “0” is no growth, “1” is 10% growth, “30” is 30% growth and “10” is 100% growth on the sample. The results are described in the following Table 6.

TABLE 6

| Name | Quantity (in ppm) | Fungal Resistance tests. |
|---|---|---|
| Control | No biocide | 3 |
| Folpet + IPBC | 1,400 + 600 | 1 |
| Folpet + IPBC | 2,800 + 1,200 | 0 |

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. A thereto-stable, arsenic-free synergistic biocide concentrate composition to provide enhanced microbicidal properties to a polymer matrix comprising:
i. (a) about 2.5 to about 50.0 wt % of trihalomethyl-thio-phthalimide; and (b) about 0.5 to about 25.0 wt % of a second biocide;
ii. about 0.5 to 20 wt % of antioxidant;
iii. a carrier; and
iv. optionally, one or more additives.

2. The biocide concentrate composition according to claim 1, wherein the composition is capable of withstanding high processing temperatures up to about 250° C.

3. The biocide concentrate composition according to claim 1, wherein the composition is free from arsenic, salts of arsenic, organic derivatives of arsenic and/or inorganic derivatives of arsenic.

4. The biocide concentrate composition according to claim 1, wherein said polymer or polymer matrix is selected from the group comprising a polyolefin, a polyacrylate, a polyvinyl chloride, a polyurethane, a polyester, a wood-plastic composite, a polycarbonate, an elastomer, a rubber, an acrylic, a nylon, a fluorocarbon, a styrenic and mixtures thereof.

5. The biocide concentrate composition according to claim 1, wherein said trihalomethyl-thio-phthalimide is N-[(trichloromethyl)thio]phthalimide.

6. The biocide concentrate composition according to claim 1, wherein said second biocide is selected from the group consisting of germicides, bactericides, fungicides, algicides, aquaticides, herbicides, insecticides, larvicides, pesticides, rodenticides, taeniacides and mixtures thereof.

7. The biocide concentrate composition according to claim 1, wherein said second biocide is selected from the group consisting of N-butyl-1,2-benzisothiazolin-3-one (BBIT), 4,5-dichloro-n-octyl-4-isothiazolin-3-one (DCOIT), triclosan, 2-methyl-4-isothiazolin-3-one (MIT), 1,2-Benzisothiazolin-3-one (BIT), 5-Chloro-2-methyl-4-isothiazolin-3-one (CMIT), 2-Octyl-4-isothiazolin-3-one (OIT), 3-iodo-2-propynylbutyl-carbamate (IPBC), oxyfluorfen, 3-iodopropynyl carbamate (IPC), 3-iodopropynyl-N-phenyl carbamate (IPPC), thiabendazole, terbutryn, zinc pyrithione (ZnPy), bronopol, diuron, dehydroacetic acid (DHA), dazomet, silver, carbendazim and mixtures thereof.

8. The biocide concentrate composition according to claim 1, wherein said antioxidant agent is selected from the group consisting of hindered phenols, amines, aryl phosphates, azoles and mixtures thereof.

9. The biocide concentrate composition according to claim 8, wherein said antioxidant agent is selected from 1,3,5-tris-(3,5-di-t-butyl-4-hydroxybenzyl)-isocyanurate,1,3,5-trimethyl-2,4,6-tris-(3,5 di-tert-butyl-4-hydroxybenzyl)-benzene, 2,2,methylenebis(6-t-butyl-4-methyl phenol), 4,4-butylidenebis(2-t-butyl-5-methylphenol), 2,5-di-t-amylhydroquinone, 1,1,3-tris-(2′methyl-4′-hydroxy-5′-t-butylphenyl)butane, 1,3,5 tris-(4-tert-butyl-3-hydroxy-2-6-dimethylbenzyl)-1,3,5triazine-2,4,6-(1H,3H,5H)-trione, 4,4′-thiobis(2-t-butyl-5-methylphenol), octadecyl-3-(3′,5′-di-tertbutyi-4-hydroxyphenyl)propionate, tris-(2,4-di-tertbutyl phenyl)phosphate and mixtures thereof.

10. The biocide concentrate composition according to claim 1, wherein said carrier is selected from the group comprising a plastic, a wax, a plasticizer and mixtures thereof.

11. The biocide concentrate composition according to claim 10, wherein said plasticizer is selected from the group comprising diisononyl phthalate, diisodecyl phthalate, butyl benzyl phthalate, ether-ester compounds, glycerin triesters, glyceryl-1,2-bisbutanoate-benzoate, glyceryl-1,3-bisbutanoate-benzoate, glyceryl-1,2-bisbenzoate-butanoate, glyceryl-1,3-bisbenzoate-butanoate, isocyanurates, esters of an anhydrosugar alcohol, aryl phosphates, phenol alkanesulphonates, dipropylene glycol dibenzoate, di(isonyl)cyclohexane dicarboxylate, diisonyl adipate, C₈-C₁₈ alkyl pyrrolidones, epoxydized soyabean oil, epoxidized linseed oil, and mixtures thereof.

12. The biocide concentrate composition according to claim 1, wherein the wt. ratio of (i) : (ii) is about 1:0.5 to 1:3.0

13. The biocide concentrate composition according to claim 1, wherein said additive is selected from the group consisting of colorants, pigments, thermal stabilizers, ultraviolet stabilizers, radiation stabilizers, mold release additives, ignition resistant additives, fillers, reinforcing aids, blowing agents, plasticizers, flow enhancers, lubricants, anti-fogging agents, anti-static compositions, anti-blocking compounds, lubricants, heat stabilizers, coupling agents, fillers, extenders, impact modifiers, glass fibers flame retardants wood, wood flour, slip agents and mixtures thereof.

14. The biocide concentrate composition according to claim 1, wherein the composition is capable of inhibiting or killing Staphylococcus aureus, Klebsiella pneumonia, Pseudomonas areuginosa, Bacillus subtilus, Aspergillus niger, Aspergillus flavus, Oscillatoria tenius, Penicillin funiculosum, Chaetomium globosum, Aureobasidium pullulans, Trichoderma Wrens, Streptoverticillium reticulum, Alternaria alternator, Curvularia sp., Fusarium sp., and/or Nigrospora sp.

15. The biocide concentrate composition according to claim 1, wherein the composition is in the form of a pellet, a liquid, a concentrate or a powder.

16. The biocide concentrate composition according to claim 1, wherein said composition is employed in the field of floral, industrial, agricultural, medical, dental, veterinary, polymer matrices, extruded and non-extruded face fibers, melt-processed polymers, outdoor fabrics, flooring materials, sanitary ceramic composites, sealing materials, industrial equipments, daily household necessities, stationery and writing materials, automobile parts, home appliances, stationary and mobile phones, copiers, textiles, quilts, pillows, blankets, transportation goods, storage racks, sporting goods, outdoor artificial turf, medical applications, dental materials, dental applications, hospital garments, sanitary napkins, musical instruments, credit cards, debit cards, polymer wood composites, construction materials, interiors and internal finishes, garden and outdoor products, industrial flooring, railings, marine pilings, marine bulkheads, fishing nets, railroad ties, pallets, furniture, synthetic wood, injection moldings, fixtures, urethane coatings, roofing materials and/or wood-plastic composites (WPC).

17. The biocide concentrate composition according to claim 1, wherein said concentrate is incorporated into a polymer matrix in a wt. ratio of about 1 to 10 concentrate to 99 to 10 polymer matrix.

18. A method of processing a biocidal polymer matrix composition comprising adding to a polymer matrix the biocide concentrate of claim 1 to produce a thermostable biocidal polymer matrix and processing said thermostable biocidal polymer matrix at an elevated temperature of about 250° C. to about 280° C., substantially without thermal degradation of the integrated biocides or discoloration of the polymer matrix.
